(19) United States
(12) Patent Application Publication
(10) Pub. No.: US 2026/0147296 A1
(43) Pub. Date: May 28, 2026

(54) FIXING DEVICE AND IMAGE FORMING APPARATUS INCORPORATING THE SAME

(71) Applicant: Yuusuke FURUICHI, Kanagawa (JP)

(72) Inventor: Yuusuke FURUICHI, Kanagawa (JP)

(21) Appl. No.: 19/351,338

(22) Filed: Oct. 7, 2025

(30) Foreign Application Priority Data
Nov. 22, 2024 (JP) 2024-203962

(51) Int. Cl. G03G 15/20; G03G 15/00

(52) U.S. Cl. CPC G03G 15/2053; G03G 15/2064; G03G 15/80; G03G 2215/2035

(57) ABSTRACT

A fixing device includes a fixing rotator, a heater, a pressure roller pressed against the fixing rotator to form a nip, and a ring. The pressure roller includes a shaft and a roller body including a conductive surface layer having an outer circumferential surface contacting a surface of the fixing rotator at the nip. The ring has conductivity, is grounded, and is disposed on the shaft to face an end face of the roller body. The end face is inclined from an edge of the outer circumferential surface to the shaft in a cross section along an axial line of the shaft and contacts the shaft at a position closer to the ring than the edge of the outer circumferential surface. The conductive surface layer has a folded portion folded along the end face of the roller body. The folded portion contacts an end face of the ring.

### CROSS-REFERENCE TO RELATED APPLICATIONS

This patent application is based on and claims priority pursuant to 35 U.S.C. § 119(a) to Japanese Patent Application No. 2024-203962, filed on Nov. 22, 2024, in the Japan Patent Office, the entire disclosure of which is hereby incorporated by reference herein.

### BACKGROUND

### Technical Field

The present disclosure relates to a fixing device that heats a toner image borne on the surface of a sheet to fix the toner image onto the sheet and an image forming apparatus including the fixing device, such as a copier, a printer, a facsimile machine, or a multifunction peripheral having at least two of copying, printing, and facsimile functions.

### Related Art

An image forming apparatus such as a copier or a printer in the related art includes a fixing device. The fixing device includes a pressure roller. Charge on the pressure roller is removed to prevent the occurrence of an abnormal image such as an electrostatic offset.

### SUMMARY

The present disclosure described herein provides a fixing device including a fixing rotator, a heater, a pressure roller, and a ring. The heater heats the fixing rotator. The pressure roller is pressed against the fixing rotator to form a nip through which a sheet is conveyed. The pressure roller includes a shaft extending in an axial direction and a roller body including a conductive surface layer having an outer circumferential surface contacting a surface of the fixing rotator at the nip. The ring has conductivity and is grounded. The ring is disposed on the shaft of the pressure roller to face an end face of the roller body. The roller body has the end face inclined from an edge of the outer circumferential surface to the shaft in a cross section along an axial line of the shaft of the pressure roller, and the end face contacts the shaft at a position closer to the ring than the edge of the outer circumferential surface. The conductive surface layer has a folded portion folded along the end face of the roller body, and the folded portion contacts an end face of the ring.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus;

FIG. 2 is a diagram illustrating a configuration of a fixing device;

FIG. 3 is a schematic cross-sectional view of the fixing device of FIG. 2 to illustrate parts extending in an axial direction of a pressure roller;

FIG. 4 is a schematic cross-sectional view of a fixing belt and flanges of the fixing device of FIG. 3 in a cross-section perpendicular to the surface of the paper on which FIG. 3 is drawn;

FIG. 5 is a cross-sectional view of a fixing device connected to a ground path;

FIG. 6 is a cross-sectional view of an end of a part of the fixing device of FIG. 5 in the axial direction;

FIG. 7 is a cross-sectional view of an end of a part of a fixing device according to a comparative example;

FIGS. 8A and 8B are diagrams each illustrating a magnitude relationship between a knurled diameter of a ring and an outer diameter of an edge of a pressure roller according to a first modification;

FIG. 9 is a cross-sectional view of an end of a part of a fixing device according to a second modification in the axial direction;

FIGS. 10A and 10B are cross-sectional views each illustrating an end of a part of a fixing device according to a third modification in the axial direction; and

FIG. 11 is a cross-sectional view of an end of a part of a fixing device according to a comparative example in the axial direction.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. Like reference signs are assigned to like elements or components and descriptions of those elements or components may be simplified or omitted.

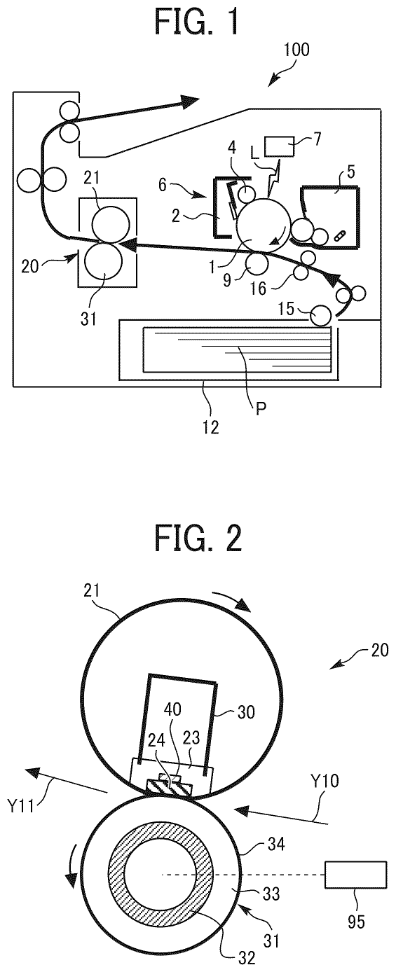

With reference to FIG. 1, the configuration and operation of an image forming apparatus 100 are described below.

In FIG. 1, the image forming apparatus 100 such as a small printer includes a process cartridge 6, an exposure device 7, a transfer roller 9, a sheet feeder 12, a registration roller pair 16 as a timing roller pair, and a fixing device 20. The process cartridge 6 is configured as a unit including a photoconductor drum 1, a charging roller 4, a developing device 5, and a cleaning device 2. The exposure device 7 irradiates the photoconductor drum 1 with exposure light L that is generated based on image data input from an input device such as a personal computer. A toner image is formed on the photoconductor drum 1. The sheet feeder 12 includes a feed tray to store sheets P. The registration roller pair 16 conveys a sheet P toward a transfer nip where the photoconductor drum 1 and the transfer roller 9 contact each other. The transfer roller 9 transfers the toner image borne on the surface of the photoconductor drum 1 onto the sheet P conveyed to the transfer nip (that is, a transfer position). The fixing device 20 fixes the toner image that has not yet been fixed, to the sheet P.

The charging roller 4, the developing device 5, and the cleaning device 2 are arranged around the photoconductor drum 1. These members (the photoconductor drum 1, the charging roller 4, the developing device 5, and the cleaning device 2) are integrated as the process cartridge 6 and are detachably (replaceably) attached to the body of the image forming apparatus 100 as the apparatus body. After a user uses the process cartridge 6 for a predetermined replacement cycle, the user removes the process cartridge 6 from the body of the image forming apparatus 100 and replaces the process cartridge 6 with a new one.

With reference to FIG. 1, typical processes of the image forming apparatus 100 are described below.

The input device such as the personal computer sends the image data to the exposure device 7 in the image forming apparatus 100, and the exposure device 7 irradiates the surface of the photoconductor drum 1 with the exposure light (a laser beam) L based on the image data.

A drive motor disposed in the body of the image forming apparatus 100 rotates the photoconductor drum 1 in the direction indicated by the arrow in FIG. 1 (clockwise). Initially, the charging roller 4 uniformly charges the surface of the photoconductor drum 1 at a position at which the surface of the photoconductor drum 1 faces the charging roller 4, which is referred to as a charging process. As a result, a charging potential (for example, approximately −900 V) is formed on the surface of the photoconductor drum 1. Subsequently, the charged surface of the photoconductor drum 1 reaches an irradiation position of the exposure light L. An electric potential at the position that receives the exposure light L changes to a latent image potential (about 0 to −100 V), and an electrostatic latent image is formed on the surface of the photoconductor drum 1, which is referred to as an exposure process.

After the exposure process, the surface of the photoconductor drum 1 on which the electrostatic latent image is formed reaches the position facing the developing device 5. The developing device 5 supplies toner onto the photoconductor drum 1 to develop the electrostatic latent image on the photoconductor drum 1 into a toner image, which is referred to as a developing process.

After the developing process, the surface of the photoconductor drum 1 bearing the toner image reaches a transfer nip (that is, a transfer position) formed between the photoconductor drum 1 and the transfer roller 9. In the transfer nip, a transfer bias having a polarity opposite the polarity of the toner is applied from a power source to the transfer roller 9, thereby transferring the toner image formed on the photoconductor drum 1 onto the sheet P conveyed by the registration roller pair 16, which is referred to as a transfer process.

The surface of the photoconductor drum 1 after the transfer process reaches a position opposite the cleaning device 2. At the position opposite the cleaning device 2, a cleaning blade mechanically removes untransferred toner remaining on the surface of the photoconductor drum 1, and the removed toner is collected in the cleaning device 2, which is referred to as a cleaning process.

Thus, a series of image forming processes on the photoconductor drum 1 is completed.

The sheet P is conveyed to the transfer nip between the photoconductor drum 1 and the transfer roller 9 as follows.

First, a feed roller 15 feeds the uppermost sheet P of the stack of sheets P stored in the sheet feeder 12 toward a conveyance passage. Subsequently, the sheet P reaches the registration roller pair 16. The sheet P that has reached the registration roller pair 16 is conveyed to the transfer nip (the contact position of the transfer roller 9 with the photoconductor drum 1) in synchronization with an entry of the toner image formed on the photoconductor drum 1 into the transfer nip.

After the sheet P passes through the transfer nip (i.e., the position of the transfer roller 9) in the transfer process, the sheet P reaches the fixing device 20 through the conveyance passage. In the fixing device 20, the sheet P is interposed between a fixing belt 21 and a pressure roller 31. The toner image is fixed on the sheet P by heat applied from the fixing belt 21 and pressure applied from both of the fixing belt 21 and the pressure roller 31, which is referred to as a fixing process. After the sheet P having the fixed toner image thereon is ejected from the fixing nip formed between the fixing belt 21 and the pressure roller 31, the sheet P is ejected from the body of the image forming apparatus 100 and stacked on an output tray.

Thus, a series of the image forming processes is completed.

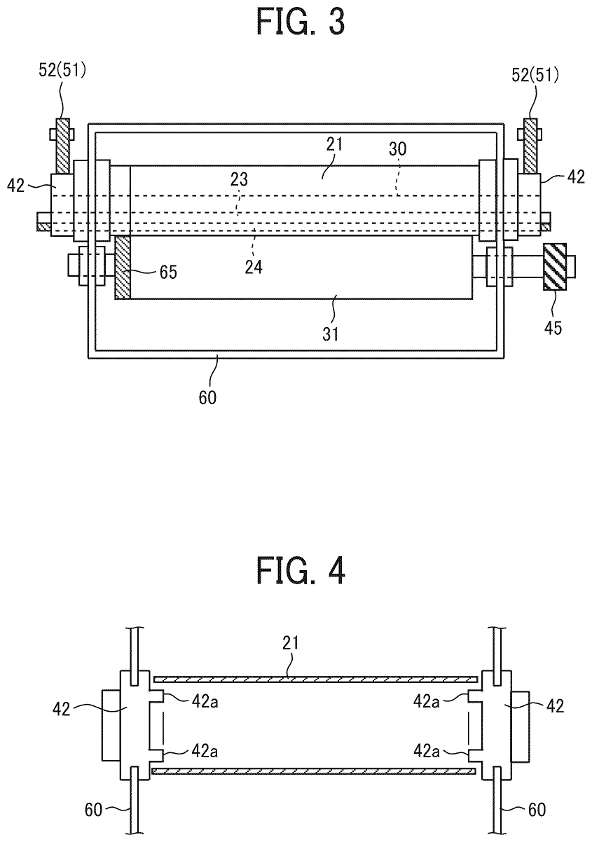

With reference to FIGS. 2 to 6, the following describes a configuration and operation of the fixing device 20. The fixing device 20 conveys the sheet P bearing an unfixed toner image while heating the sheet P. With reference to FIG. 2, the fixing device 20 includes the fixing belt 21 as a fixing rotator, a planar heater 24 as a heat source (a heating means), a holder 23, a stay 30, a thermistor 40, the pressure roller 31 as a pressure rotator, and a ring 65 (see FIGS. 3, 5, and 6).

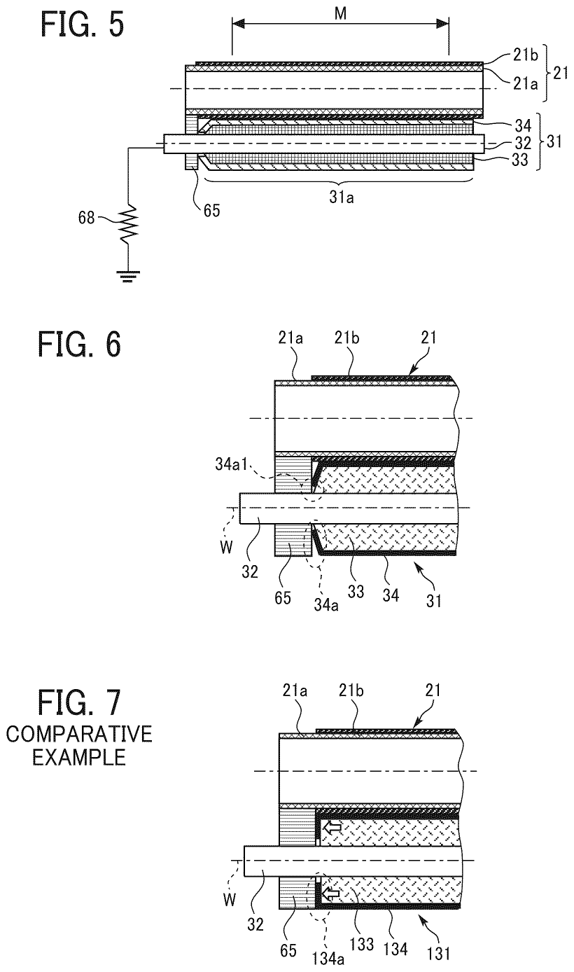

The fixing belt 21 is an endless belt disposed in contact with an outer circumferential surface of the pressure roller 31 and driven to rotate by rotation of the pressure roller 31. The fixing belt 21 is a thin and flexible endless belt driven to rotate clockwise in FIG. 2, that is, in a rotation direction indicated by an arrow in FIG. 2. With reference to FIG. 5, the fixing belt 21 includes a base layer 21a as a belt conductive layer having an inner circumferential surface (i.e., a sliding contact surface of the fixing belt 21 sliding over the planar heater 24) and a belt surface layer 21b as a surface layer having an insulating property (or a medium resistance) and being layered on the base layer 21a. A total thickness of the fixing belt 21 is designed to be equal to or smaller than 1 mm.

The base layer 21 a of the fixing belt 21 has a thickness in a range of from 30 μm to 50 μm. The base layer 21 a is made of metal, such as nickel or stainless steel, or carbon-dispersed resin such as carbon-dispersed polyimide and functions as the belt conductive layer having conductivity.

The belt surface layer 21 b of the fixing belt 21 has a thickness in a range of from 5 μm to 50 μm. The belt surface layer 21 b is made of an insulating material such as tetrafluoroethylene-perfluoroalkyl vinyl ether copolymer (PFA), polytetrafluoroethylene (PTFE), polyimide, polyether imide, and polyether sulfone (PES). The belt surface layer 21b having the insulating property facilitates the separation of toner contained in the toner image on the sheet P from the fixing belt 21.

In the above, the belt surface layer 21b is made of an insulating material but may be made of a material having a medium resistance by dispersing a relatively small amount of carbon in the above-described insulating material. The specific resistance value range of the medium resistance is equal to or greater than 10⁷ Ω/□ and less than 10¹⁰ Ω/□. As a result, the belt surface layer 21b has a resistance larger than the base layer 21a as the belt conductive layer.

Inside the loop of the fixing belt 21, the planar heater 24, the holder 23, the stay 30, and the thermistor 40 are disposed

The planar heater 24 is disposed so as to extend in a width direction that is a direction perpendicular to the surface of the paper on which FIG. 2 is drawn, the lateral direction in each of FIGS. 3 to 6, and an axial direction of the pressure roller 31. The planar heater 24 contacts the inner circumferential surface of the fixing belt 21. The planar heater 24 is pressed against the pressure roller 31 via the fixing belt 21 to form the fixing nip through which the sheet P is conveyed. The planar heater 24 is disposed inside the loop formed by the fixing belt 21 such that the inner circumferential surface of the fixing belt 21 slides over the planar heater 24. Pressing the planar heater 24 against the pressure roller 31 via the fixing belt 21 forms the fixing nip between the fixing belt 21 and the pressure roller 31, through which the sheet P is conveyed. As described above, the planar heater 24 functions as a nip formation pad that is a member forming the fixing nip.

In addition, the planar heater 24 includes a resistor pattern (in other words, a resistive heat generator) formed on a portion that is in sliding contact with the inner circumferential surface of the fixing belt 21. A power supply supplies electric power to the resistor pattern, and the resistor pattern generates heat according to the resistance of the resistor pattern to heat the fixing belt 21. As described above, the planar heater 24 also functions as a heater to heat the fixing belt 21.

To reduce sliding friction between the inner circumferential surface of the fixing belt 21 and the planar heater 24, a lubricant such as silicon oil or fluorine grease is directly applied to the inner circumferential surface of the fixing belt 21.

Instead of directly applying the lubricant to the inner circumferential surface of the fixing belt 21, the lubricant may be indirectly applied to the inner circumferential surface of the fixing belt 21 by applying the lubricant to the sliding contact surface of the planar heater 24 on which the fixing belt 21 slides.

In addition to applying the lubricant to the inner circumferential surface of the fixing belt 21, the planar heater 24 may include a surface layer or a sheet made of a low friction material such as PTFE on the surface of the planar heater 24.

The holder 23 holds the planar heater 24. The holder 23 has a recess, and the planar heater 24 is fitted into the recess to hold the planar heater 24 in the width direction that is the axial direction. The stay 30 holds the holder 23 holding the planar heater 24. The fixing device 20 includes a frame 60. The frame 60 holds both ends of the stay 30 holding the planar heater 24 and the holder 23 in the width direction via flanges 42 (see FIG. 3).

As described above, the planar heater 24 (the resistor pattern) disposed inside the loop of the fixing belt 21 directly heats the fixing belt 21. The outer circumferential surface of the fixing belt 21 heated by the planar heater 24 heats the toner image on the sheet P.

The output of the planar heater 24 is controlled based on the temperature of the planar heater 24 detected by the thermistor 40. The thermistor 40 directly contacts the planar heater 24 (or indirectly contacts the planar heater 24 via another member). The fixing device 20 according to the present embodiment does not include a temperature sensor that directly detects the surface temperature of the fixing belt 21. A controller controls the temperature of the planar heater 24 detected by the thermistor 40 to indirectly control the surface temperature (that is a fixing temperature) of the fixing belt 21 to a desired temperature.

With reference to FIG. 4, a pair of flanges 42 guides ends of the inner circumferential surface of the fixing belt 21 in the width direction of the fixing belt 21 such that the fixing belt 21 maintains a substantially cylindrical posture.

Specifically, the two flanges 42 are made of a heat-resistant resin material and are held by both sides of the frame 60 in the width direction of the frame 60 of the fixing device 20 so that each of the flanges 42 can slide and move along each of the sides of the frame 60 in a direction forming the fixing nip. Each of the flanges 42 includes a guide 42a and a stopper. The guides 42a hold the fixing belt 21 to maintain the substantially cylindrical posture of the fixing belt 21. The stopper restricts motion or skew of the fixing belt 21 in the width direction of the fixing belt 21.

As illustrated in FIG. 3, the fixing device 20 includes pressing levers 52 of a pressing device 51. The pressing levers press the flanges 42 such that the fixing belt 21, the planar heater 24, and the holder 23 press the pressure roller 31. The flanges 42 are disposed to support both ends of the loop of the fixing belt 21 in the width direction except for portions facing both ends of the fixing nip so that the planar heater 24 can form the fixing nip. The inner circumferential surface of the fixing belt 21 is loosely contacted only by the planar heater 24 and the flanges 42 at respective ends of the fixing belt 21 in the width direction thereof. No other component, such as a belt guide, contacts the inner circumferential surface of the fixing belt 21 to guide the fixing belt 21 as it rotates.

The fixing device 20 includes the stay 30 that is disposed inside the loop of the fixing belt 21 so as to be in contact with the pressure roller 31 via the holder 23, the planar heater 24, and the fixing belt 21. The stay 30 reinforces the planar heater 24 forming the fixing nip (and the holder 23), enhancing the mechanical strength of the holder 23 and the planar heater 24. The stay 30 is assembled to the frame 60 (or the holder 23) by screw fastening or other fasteners.

The stay 30 receiving the pressure from the pressure roller 31 via the holder 23, the planar heater 24, and the fixing belt 21 prevents a disadvantage that the pressure from the pressure roller 31 largely deforms the planar heater 24 (and the holder 23) at the fixing nip. Preferably, the stay 30 is made of metal having an increased mechanical strength, such as stainless steel or iron, to achieve the above-described function.

The holder 23 may be made of resin or metal. Preferably, the holder 23 is made of resin that has rigidity to prevent the holder 23 from bending even if the holder 23 receives pressure from the pressure roller 31, and the resin preferably has heat resistance and thermal insulation. The resin may be liquid crystal polymer (LCP), polyamide imide (PAI), polyether sulfone (PES), polyphenylene sulfide (PPS), polyether nitrile (PEN), and polyether ether ketone (PEEK). The holder 23 according to the present embodiment is made of liquid crystal polymer (LCP).

With reference to FIG. 2, the pressure roller 31 as the pressure rotator includes a cored bar 32 serving as a shaft, an elastic layer 33 layered on the cored bar 32, and a conductive surface layer 34 layered on the elastic layer 33. The pressure roller 31 is driven and rotated counterclockwise in FIG. 2 by a drive motor 95.

The cored bar 32 (the shaft) of the pressure roller 31 has a hollow structure made of metal (the conductive material). The elastic layer 33 of the pressure roller 31 is made of an insulating material such as silicone rubber foam, silicone rubber, or fluororubber.

The conductive surface layer 34 of the pressure roller 31 is thin and functions as a release layer. The conductive surface layer 34 is made of PFA or PTFE in which carbon is dispersed to have conductivity. The material of the conductive surface layer 34 has a tubular shape. The material of the conductive surface layer 34 is set on the elastic layer 33 so that the tube covers the elastic layer 33. Thermal processing is performed to form the conductive surface layer 34. The conductive surface layer 34 is described in more detail below with reference to FIG. 6.

The pressure roller 31 is pressed against the fixing belt 21 to form a desired nip (the fixing nip) between the fixing belt 21 and the pressure roller 31. As illustrated in FIG. 3, a gear 45 is attached to the pressure roller 31 and engages a driving gear of the drive motor so that the pressure roller 31 is driven and rotated counterclockwise in FIG. 2, that is, a direction indicated by the arrow in FIG. 2. Both ends of the pressure roller 31 in the axial direction are rotatably supported by the frame 60 of the fixing device 20 through bearings, respectively.

The fixing device 20 according to the present embodiment also includes the ring 65, which is described in detail below.

A description is provided of a regular fixing process to fix the toner image on the sheet P, which is performed by the fixing device 20 having the construction described above.

When the controller in the image forming apparatus 100 receives a print instruction, the controller controls the power supply to supply the electric power to the planar heater 24 and controls the drive motor 95 to start rotating the pressure roller 31 in the direction indicated by the arrow in FIG. 2. Due to driving and rotating the pressure roller 31, friction between the pressure roller 31 and the fixing belt 21 at the fixing nip rotates the fixing belt 21 in a direction indicated by an arrow in FIG. 2.

After the fixing belt 21 rotates, the sheet P is fed from the sheet feeder 12, and the toner image is transferred onto the sheet P at the position of the transfer roller 9. As a result, the sheet P bears an unfixed toner image. As illustrated in FIG. 2, the sheet P bearing the unfixed toner image is conveyed in a direction indicated by an arrow Y10 while the sheet P is guided by the entrance guide plate and enters the fixing nip formed between the fixing belt 21 and the pressure roller 31 pressed against the fixing belt 21.

The planar heater 24 heats the fixing belt 21. The planar heater 24 and the holder 23 are reinforced by the stay 30 and pressed against the pressure roller 31. The heat in the fixing belt 21 and the pressure between the planar heater 24 and the pressure roller 31 fix the toner image on the surface of the sheet P. After the toner image is fixed on the surface of the sheet P, the sheet P is sent out from the fixing nip, and an exit guide plate guides the sheet P to be conveyed in a direction indicated by an arrow Y11 in FIG. 2.

The following describes the configuration and operation of the fixing device 20 in detail, which is characteristic of the image forming apparatus 100 according to the present embodiment.

As described above with reference to FIGS. 2 and 5, the fixing belt 21 includes the base layer 21a as the belt conductive layer having conductivity. In addition, the fixing belt 21 includes the belt surface layer 21b having the insulating property (or the belt surface layer having the medium resistance) directly layered on the base layer 21a (the belt conductive layer).

In other words, the fixing belt 21 according to the present embodiment has a two layer structure including the base layer 21a as the belt conductive layer having conductivity and the belt surface layer 21b having the insulating property or the medium resistance and layered on the base layer 21a. The belt surface layer 21b has a resistance larger than the base layer 21a.

In particular, the fixing belt 21 is formed so that one end of the base layer 21a (the belt conductive layer) in the width direction that is a left end of the base layer 21a in FIG. 5 projects from one end of the belt surface layer 21b in the width direction, and the ring 65 is disposed on the above-described one end of the base layer 21a. In other words, the base layer 21a as the belt conductive layer having conductivity has a portion exposed that is one end portion of the base layer 21a in the axial direction of the pressure roller 31, and the ring 65 is disposed on the exposed portion. The exposed portion is not covered by the belt surface layer 21b.

The above-described one end of the base layer 21a (the belt conductive layer) projecting from the above-described one end of the belt surface layer 21b in the axial direction directly contacts the ring 65 described below (in other words, a contact area is formed).

As a result, the belt surface layer 21b is layered on a part of the base layer 21a (the belt conductive layer) extending in the width direction (the lateral direction in FIGS. 5 and 6 and the axial direction of the pressure roller 31) except for the above-described one end of the base layer facing the contact area on which the base layer 21a is in contact with the ring 65 described below. In other words, the belt surface layer 21b is directly laminated on the base layer 21a in a range extending in the width direction except for the exposed portion of the base layer 21a.

On the other hand, the pressure roller 31 as the pressure rotator includes the conductive surface layer 34 that has the conductivity and is in contact with the belt surface layer 21b of the fixing belt 21 as the fixing rotator to form the fixing nip. The pressure roller 31 has a roller body 31a including the elastic layer 33 and the conductive surface layer 34 that are laminated on the cored bar 32. The cored bar 32 as the shaft of the pressure roller 31 projects from both ends of the roller body 31a to be exposed. The roller body 31a does not include both ends of the cored bar 32 that are exposed. The conductive surface layer 34 is formed in the roller body 31a so as to be in contact with the surface of the fixing belt 21 at the fixing nip.

As illustrated in FIGS. 5 and 6, the ring 65 is disposed on the cored bar 32 as the shaft of the pressure roller 31 as the pressure rotator of the fixing device 20. The ring 65 has conductivity and is grounded. The ring 65 faces an end face of the roller body 31a. The ring 65 contacts and is electrically connected to the exposed portion of the base layer 21a (the belt conductive layer). The exposed portion of the base layer 21a is one end of the base layer 21a in the width direction, and the belt surface layer 21b is not laminated on the exposed portion. Accordingly, the ring 65 contacts and is electrically connected to the conductive surface layer 34 of the pressure roller 31 and the base layer 21a of the fixing belt 21 (the belt conductive layer).

Specifically, as illustrated in FIGS. 5 and 6, the ring 65 has a ring shape (in other words, a doughnut shape) and is made of a conductive material. In particular, the ring 65 in the present embodiment has a knurled outer circumferential surface having multiple projections and recesses and contacting the exposed portion of the base layer 21a as the belt conductive layer. The ring 65 as the ring functions as a conductor to ground the base layer 21a as the belt conductive layer of the fixing belt 21 and the conductive surface layer 34.

The cored bar 32 of the pressure roller 31 is inserted into the ring 65. In other words, the ring 65 is disposed on the cored bar 32 of the pressure roller 31 so as to contact the base layer 21a (the belt conductive layer) of the fixing belt 21 and the end face of the roller body 31a of the pressure roller 31. The cored bar 32 functions as the shaft of the end of the pressure roller 31. The ring 65 rotates in a predetermined direction (counterclockwise in FIG. 2) together with the pressure roller 31.

The ring 65 has an outer diameter (the outer diameter of the knurled portion) substantially equal to or slightly larger than the outer diameter of the roller body 31a (that includes the elastic layer 33 and the conductive surface layer 34) of the pressure roller 31. The projection of the knurl of the ring 65 is in contact with the base layer 21a of the fixing belt 21 (specifically, the exposed portion of the belt conductive layer).

Even if the outer diameter of the ring 65 (that is, the outer diameter of the knurled portion) is equal to the outer diameter of the roller body 31a of the pressure roller 31, the ring 65 (the projection) contacts the base layer 21a (the belt conductive layer) and is electrically connected to the base layer 21a. This is because the belt surface layer 21b is extremely thin and the pressure roller 31 is pressed against the fixing belt 21 so as to deform the fixing belt 21 and the pressure roller 31.

The ring contacting the base layer 21a (the belt conductive layer) of the fixing belt 21 in the present embodiment has a knurled shape having multiple projections (a spur gear shape in the present embodiment). The multiple projections arranged at intervals in the circumferential direction and the width direction intermittently contacts the base layer 21a. The ring having the multiple projections is less likely to cause a contact failure such as a partial contact than the ring having a perfect ring shape and contacting the base layer 21a. As a result, the ring having the multiple projections generates satisfactorily, stably, and relatively large contact pressure and stably electrically couples between the base layer 21a and the ring.

The ring 65 is press-fitted into the cored bar 32 to enhance conductivity (electrical connectivity) with the cored bar 32 as the shaft. In order to prevent the ring 65 from being displaced on the cored bar 32 in the width direction (the axial direction), the ring 65 may be bonded and fixed to the cored bar 32 by a conductive adhesive.

As illustrated in FIG. 5, the ring 65 is grounded (earthed) via the cored bar 32.

Specifically, the cored bar 32 is connected to a grounding wire including the frame 60 grounded via a resistor 68 (an electric resistance member). Thus, the ring 65 is favorably grounded. The ring 65 is disposed outside a maximum sheet passing region M in the fixing device 20 (in other words, disposed in a non-sheet passing region). The maximum sheet passing region M is defined as a region in the width direction through which a sheet P having a maximum size that can be conveyed passes. As a result, the ring 65 does not contact the fixed image and does not affect the fixed image.

As described above, the fixing device 20 according to the present embodiment includes the ring 65 functioning as the conductor. The ring 65 is grounded and satisfactorily and electrically connected to the base layer 21a (the belt conductive layer) of the fixing belt 21 and the conductive surface layer 34 of the pressure roller 31. The above-described structure is less likely to accumulate electric charge in the fixing belt 21 and the pressure roller 31 and reduces the occurrence of an abnormal image such as an electrostatic offset caused by the electric charge accumulation.

The electrostatic offset occurs as follows in the fixing process. When the sheet P that bears the toner enters the fixing nip, the toner electrostatically moves and adheres to the fixing belt 21 as the fixing rotator. After the fixing belt 21 rotates once, the toner adhered to the fixing belt 21 adheres to the sheet P again. As a result, the electrostatic offset occurs.

The above-described movement of toner to the fixing belt 21 is caused by charge on the surfaces of the fixing belt 21 and the pressure roller 31. In the present embodiment, the toner is negatively charged. when the fixing belt 21 is positively charged, the toner receives an electrostatic adsorptive force from the fixing belt 21. When the pressure roller 31 is negatively charged, the toner receives an electrostatic repulsive force from the pressure roller 31. As a result, the toner adheres to the fixing belt 21.

To countermeasure the above-described phenomenon, in the fixing device 20 according to the present embodiment, the charge is removed from the base layer 21a (the belt conductive layer) of the fixing belt 21 and the conductive surface layer 34 of the pressure roller 31 as described above. As a result, the surfaces of the fixing belt 21 and the pressure roller 31 are less likely to be charged. Therefore, the electrostatic offset is less likely to occur.

As illustrated in FIG. 6, the end face of the roller body 31a of the pressure roller 31 (the end face facing the ring 65) has a tapered shape inclined so as to approach the ring 65 from an edge of the outer circumferential surface of the pressure roller 31 toward an axial line W of the cored bar 32 of the pressure roller 31 when viewed in a cross section including the axial line W extending in the axial direction.

In other words, an outer diameter of an end of the roller body 31a in the axial direction is smaller than an outer diameter of another portion of the roller body 31a not having the tapered shape that is referred to as an outer diameter of the pressing roller. One end of the roller body 31a in the axial direction has a substantially truncated cone shape. The above-described one end of the roller body 31a has an inclined face. In other words, the roller body 31a has the end face inclined from the edge of the outer circumferential surface of the pressure roller 31 to the cored bar 32 as the shaft in the cross section along the axial line W of the cored bar 32 of the pressure roller 31, and the end face contacts the cored bar 32 at a position closer to the ring than the edge of the outer circumferential surface.

Note that the roller body 31a has the above-described shape at room temperature before the roller body 31a thermally expands in the fixing process.

As illustrated in FIG. 6, the conductive surface layer 34 of the pressure roller 31 according to the present embodiment has a folded portion 34a forming one end of the roller body in the axial direction that is the left end of the pressure roller 31 in FIGS. 5 and 6. The ring 65 is disposed adjacent to the folded portion 34a. The material of the conductive surface layer 34 of the pressure roller 31 is folded from the edge of the outer circumferential surface of the pressure roller 31 toward the center axis W of the pressure roller 31 along the inclined end face of the roller body 31a to form the folded portion 34a. The folded portion 34a has a shape in which the conductive surface layer 34 is folded but may not made by a manufacturing process that actually folds the material of the conductive surface layer 34. In particular, the conductive surface layer 34 in the present embodiment has a tubular shape substantially covering the entire outer peripheral surface of the elastic layer 33 and the end faces of the elastic layer 33.

The folded portion 34a contacts the end face of the ring 65.

In other words, one end of the conductive surface layer 34 in the width direction (in other words, one end in the axial direction) has a shape folded so as to extend along an inclined end face of the elastic layer 33 as illustrated in FIGS. 5 and 6. The conductive surface layer 34 has the tip 34a1 of the above-described one end, and the tip 34a1 forms a small diameter portion adjacent to the cored bar 32 and contacts the end face of the ring 65.

As described above, the conductive surface layer 34 has the folded portion 34a along one end of the roller body 31a (the elastic layer 33) having the inclined end face to form the tapered shape, and the tip 34a1 of the folded portion 34a contacts the end face of the ring 65. This structure is less likely to cause contact failure (conduction failure) between the folded portion 34a and the end face of the ring 65 even when the pressure roller 31 thermally expands during the fixing process (during actual use) to deform the shape of the end face of the roller body 31a.

The following describes the contact failure (the conduction failure) between the folded portion and the end face of the ring with reference to FIG. 7. FIG. 7 is a cross-sectional view of an end of a part of a fixing device according to a comparative example. The fixing device according to the comparative example includes a pressure roller 131. The pressure roller 131 has a roller body (an elastic layer 133) having an end face that is a flat face substantially perpendicular to the axial line W. A conductive surface layer 134 in the comparative example has a folded portion 134a extending along the end face perpendicular to the axial line W. The pressure roller 31 thermally expands during the fixing process (during the actual use) to cause deformation of the end face. In this structure, the deformation of the end face is likely to cause the contact failure (the conduction failure) between the folded portion 134a and the end face of the ring. An inner diameter portion of the pressure roller 31 (the roller body 31a) is bonded (joined) to the cored bar 32 and is less likely to thermally expand, but an outer diameter portion of the pressure roller 31 is not bonded to the cored bar 32. The outer diameter portion of the pressure roller 31 is not restricted by being bonded to the cored bar 32 and is likely to thermally expand in the direction indicated by the white arrow in FIG. 7. The above-described thermal expansion of the roller body 31a pushes and deforms the ring 65 and is likely to cause the contact failure (the conduction failure) between the folded portion and the end face of the ring 65.

In contrast, the pressure roller 31 (the roller body 31a) according to the present embodiment is designed to have one end in the axial direction having the substantially truncated cone shape and the folded portion 34a extending along the shape of the above-described one end in advance in anticipation of the thermal expansion of the pressure roller 31 (the roller body 31a) during the fixing process (during the actual use) as described above with reference to FIG. 7. As a result, the contact failure (the conduction failure) between the folded portion 34a and the end face of the ring 65 is less likely to occur. The thermal expansion of the roller body 31a during the fixing process (during the actual use) further facilitates the folded portion 34a on the outer diameter potion to come into contact with the end face of the ring 65 in addition to the folded portion on the inner diameter portion, which enables obtaining a sufficient contact area between the conductive surface layer 34 and the ring.

As a result, the charge in the surface (the conductive surface layer 34) of the pressure roller 31 is sufficiently removed, and the occurrence of the abnormal image such as the electrostatic offset is sufficiently reduced.

The following describes a first modification.

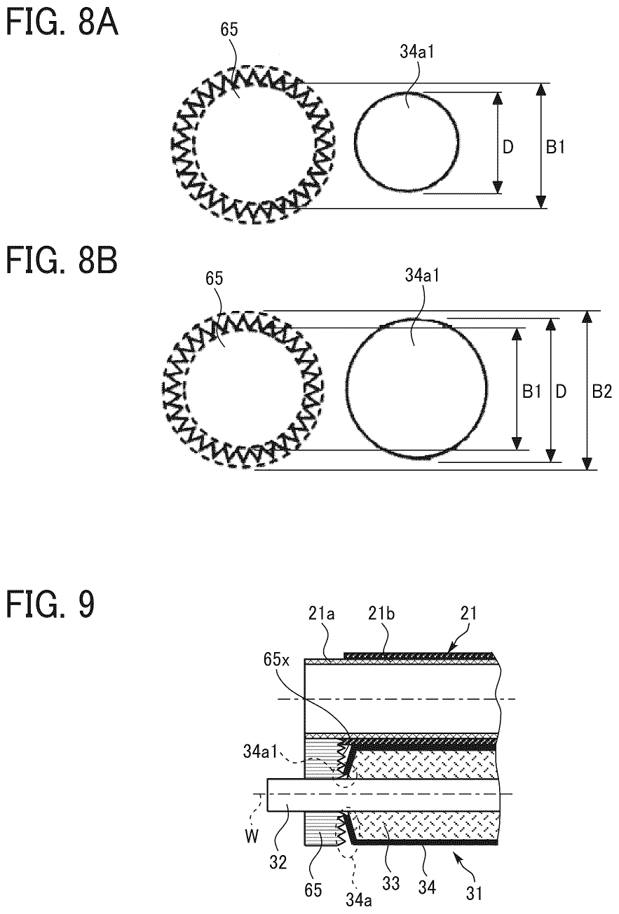

Just like the fixing device 20 illustrated in FIG. 6, the ring 65 disposed in the fixing device 20 according to the first modification has the knurled outer circumferential surface contacting and being electrically connected to the exposed portion of the base layer 21a as the belt conductive layer of the fixing belt 21. With reference to FIGS. 8A and 8B, the first modification is described below.

As illustrated in FIG. 8A, the roller body 31a (see FIG. 5) in the fixing device 20 has an edge facing the ring 65 in the axial direction. The edge of the roller body 31a has an outer diameter D that is an outer diameter formed by the tip 34a1 (in other words, the outer diameter of the small diameter portion). The outer diameter D is designed to be smaller than the inner diameter B1 of the knurled portion of the ring 65 that is the diameter of a circle drawn by connecting bottoms of recesses of the knurled portion (D<B1).

In this case, the tip 34a1 of the conductive surface layer 34 of the roller body 31a (in other words, the small diameter portion) abuts against the end face of the ring 65 in a circle area having the inner diameter B1 of the knurled portion. This configuration can obtain a sufficient contact area between the conductive surface layer 34 and the ring 65.

In contrast, the roller body 31a in the fixing device 20 illustrated in FIG. 8B has the outer diameter D of the edge of the roller body 31a facing the ring 65 in the axial direction that is the outer diameter of the tip 34a1 (in other words, the outer diameter of the small diameter portion), and the outer diameter D is designed to be larger than the inner diameter B1 of the knurled portion of the ring 65 that is the diameter of the circle drawn by connecting bottoms of recesses of the knurled portion. In addition, the outer diameter D is designed to be smaller than the outer diameter B2 of the knurled portion of the ring 65 that is the diameter of the circle drawn by connecting tops of projections of the knurled portion (B1<D<B2).

In this case, the tip 34a1 of the conductive surface layer 34 of the roller body 31a (in other words, the small diameter portion) abuts against side faces of multiple projections of the knurled portion of the ring 65. As a result, the multiple projections arranged at intervals in the circumferential direction intermittently contacts the base layer 21a. The ring having the multiple projections is less likely to cause a contact failure such as a partial contact. As a result, the ring having the multiple projections generates satisfactorily, stably, and relatively large contact pressure and stably electrically couples between the base layer 21a and the ring.

In the fixing device 20 according to the first modification, the charge on the surface of the pressure roller 31 can be sufficiently removed.

Although the outer diameter D of the edge of the roller body 31a is set to be equal to the outer diameter formed by the tip 34a1 in the above-described first modification, the conductive surface layer 34 may be extended from the edge of the roller body 31a to the cored bar 32. In this case, the ring 65 contacts an area from the edge of the roller body 31a to the tip 34a1 of the conductive surface layer 34.

The following describes a second modification.

As illustrated in FIG. 9, the ring 65 in the fixing device 20 according to the second modification has a knurled end face facing the roller body 31a (see FIG. 5). Just like the fixing device illustrated in FIG. 6, the pressure roller 31 (the roller body 31a) in the fixing device 20 according to the second modification also has one end in the axial direction having the substantially truncated cone shape and the folded portion 34a extending along the shape of the above-described one end. Forming the knurled end face of the ring 65 causes the multiple projections arranged at intervals on the end face to be in contact with the folded portion 34a, which is less likely to cause the contact failure such as the partial contact. As a result, the ring having the knurled end face generates satisfactorily, stably, and relatively large contact pressure and stably electrically couples to the folded portion 34a of the conductive surface layer 34. In the fixing device 20 according to the second modification, the charge on the surface of the pressure roller 31 can be sufficiently removed.

The following describes a third modification.

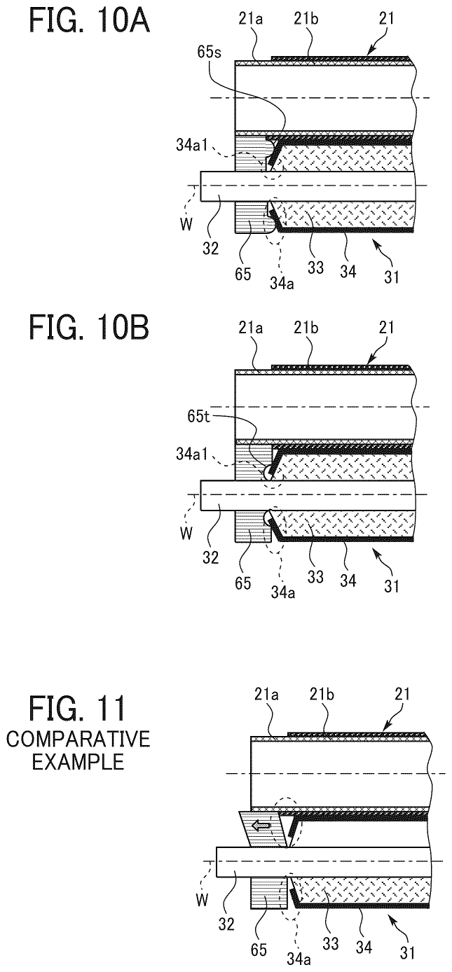

As illustrated in FIG. 10A, the ring 65 in the fixing device 20 according to the third modification has multiple projections 65s adjacent to the outer circumferential surface on the end face facing the roller body 31a, and the multiple projections 65s are arranged at intervals in the circumferential direction of the ring 65. Alternatively, the ring 65 may have one projection 65s having a circumferential shape and being adjacent to the outer circumferential surface on the end face facing the roller body 31a.

In contrast, the ring 65 illustrated in FIG. 10B has multiple recesses 65t adjacent to the inner circumferential surface on the end face facing the roller body 31a (see FIG. 5), and the multiple recesses 65t are arranged at intervals in the circumferential direction of the ring 65. Alternatively, the ring 65 may have one recess 65t having a circumferential shape and being adjacent to the inner circumferential surface on the end face facing the roller body 31a.

The ring 65 illustrated in each of FIGS. 10A and 10B has a portion adjacent to the outer circumferential surface of the ring 65, and the portion adjacent to the outer circumferential surface of the ring 65 contacts the folded portion 34a folded along the inclination of the end face of the roller body 31a. In other words, the ring 65 has a first portion adjacent to an outer circumferential surface of the ring and a second portion adjacent to an inner circumferential surface of the ring, and the first portion and the second portion are on the end face facing the roller body 31a. The first portion is in contact with the folded portion 34 a. The ring has one of the projection 65 a on the first portion or the recess 65t in the second portion.

The above-described configuration can reduce the contact failure (the conduction failure) between the folded portion 34a and the end face of the ring 65.

The following describes the above-described contact failure (the conduction failure) between the folded portion and the end face of the ring with reference to FIG. 11. FIG. 11 is a cross-sectional view of an end of a part of a fixing device according to a comparative example. The fixing device according to the comparative example includes a ring not having the projection 65s and the recess 65t. In this case, the elastic layer 33 of the pressure roller 31 compressed at the fixing nip expands in the axial direction due to the Poisson ration. If the expansion of the elastic layer 33 pushes and deforms (tilts) the ring 65, the contact failure (the conduction failure) between the folded portion and the end face of the ring is likely to occur.

In contrast, the ring 65 in the third modification has the projection 65s or the recess 65t in anticipation of deformation (tilts) of the ring 65 as illustrated in FIG. 11 so as to maintain the contact between the folded portion 34a and the ring 65 even if the above-described deformation occurs, and thus the above-described disadvantage is less likely to occur.

In the fixing device 20 according to the third modification, the charge on the surface of the pressure roller 31 can be sufficiently removed.

As described above, the fixing device 20 includes the planar heater 24 as the heater, the fixing belt 21 as the fixing rotator, and the pressure roller 31 as the pressure rotator. The planar heater 24 heats the fixing belt 21. The pressure roller 31 is pressed against the fixing belt 21 to form the fixing nip through which the sheet P is conveyed. The pressure roller 31 includes the conductive surface layer 34 having conductivity. The conductive surface layer 34 is formed on the roller body 31a of the pressure roller 31 to contact the surface of the fixing belt 21 at the fixing nip N. The ring 65 has conductivity and is grounded. The ring 65 is disposed on the cored bar 32 (as the shaft) of the pressure roller 31 such that ring 65 faces the end face of the roller body 31a. The end face of the roller body 31a is inclined so as to approach the ring 65 from the outer circumferential surface of the pressure roller 31 toward the axial line W of the pressure roller 31 when viewed in the cross section including the axial line W. The conductive surface layer 34 has the folded portion 34a having the shape folded from the edge of the outer circumferential surface of the pressure roller 31 to the roller center axis of the pressure roller 31 along the inclination of the end face of the roller body 31a. The folded portion 34a is disposed on the end of the roller body in the axial direction of the pressure roller 31 that is the same as the width direction, the end facing the ring 65. The folded portion 34a is in contact with the end face of the ring 65.

The above-described configuration can sufficiently remove the charge on the surface of the pressure roller 31.

In the above embodiments and modifications, the present disclosure is applied to the fixing device 20 including the planar heater 24 as the heater. However, the fixing device to which the present disclosure is applied is not limited to this. For example, the present disclosure may be applied to the fixing device including an electromagnetic induction coil as the heater.

In the above embodiments and the modifications, the present disclosure is applied to the fixing device 20 including the fixing belt 21 as the fixing rotator. However, the fixing device to which the present disclosure is applied is not limited to this. For example, the present disclosure may be applied to the fixing device including a fixing roller or a fixing belt stretched around multiple rollers as the fixing rotator.

In the above embodiments and modifications, the fixing belt 21 includes the base layer 21a as the belt conductive layer. Alternatively, the fixing belt 21 may include the belt surface layer 21b and a conductive elastic layer sequentially layered on the base layer 21a to form a three layer structure. In this case, the belt surface layer 21b is indirectly layered over the base layer 21a. The belt surface layer 21b directly or indirectly layered over the base layer 21a may be expressed as the belt surface layer over the base layer. The conductive elastic layer may be used as the belt conductive layer.

In the above embodiments and modifications, the ring 65 has the knurled outer circumferential surface. However, the ring does not necessarily have the knurled outer circumferential surface. For example, a gear may be used as the ring.

In the above embodiments and modifications, the planar heater 24 as the heater serves as the nip formation pad and is pressed against the pressure roller 31 via the fixing belt 21 to form the fixing nip. However, the nip formation pad may not be the heater.

In the above embodiments and modifications, the ring 65 contacts the folded portion34a of the pressure roller 31 and the base layer 21a of the fixing belt 21 to form the grounding path. However, the ring 65 may contact the folded portion34a of the pressure roller 31 to form the grounding path, and the base layer 21a of the fixing belt 21 may form another grounding path.

The above-described configurations also provide similar effects to those of the above-described embodiments and the modifications.

Note that embodiments of the present disclosure are not limited to the above-described embodiments, and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

In the present description, the term “sheet” is defined as any sheet-like recording medium including all conveyed objects, such as typical paper, coated paper, label paper, overhead projector (OHP) transparency, or a film sheet.

Aspects of the present disclosure are, for example, as follows.

### First Aspect

In a first aspect, a fixing device includes a fixing rotator heated by a heater and a pressure roller pressed against the fixing rotator to form a nip through which a sheet is conveyed. The pressure roller has a roller body and includes a conductive surface layer having conductivity. The conductive surface layer is formed in the roller body so as to contact a surface of the fixing rotator at the nip. A ring having conductivity and being grounded is disposed on a shaft of the pressure roller so as to face an end face of the roller body. The end face of the roller body is inclined so as to approach the ring from an outer circumferential surface of the pressure roller toward a roller center axis of the pressure roller when viewed in a cross section including the roller center axis. The conductive surface layer has a folded portion on an edge of the roller body in a width direction, the edge facing the ring. The folded portion has a shape folded along the inclined end face of the roller body from the edge of the outer circumferential surface of the roller body toward the roller center axis. The folded portion contacts an end face of the ring.

### Second Aspect

In a second aspect, the fixing device according to the first aspect includes a fixing belt as the fixing rotator. The fixing belt includes a belt conductive layer having conductivity and a belt surface layer having an insulating property or a medium resistance. The belt surface layer is directly or indirectly layered on a part of the belt conductive layer except for an exposed portion formed at an end of the belt conductive layer in the width direction. The ring contacts and is electrically connected to the exposed portion of the belt conductive layer.

### Third Aspect

In a third aspect, the fixing device according to the second aspect is characterized in that the ring has a knurled outer circumferential surface in contact with the exposed portion of the belt conductive layer.

### Fourth Aspect

In a fourth aspect, the fixing device according to the third aspect is characterized in that an outer diameter of the edge of the roller body in the width direction, the edge facing the ring is smaller than an inner diameter of the knurled outer circumferential surface of the ring.

### Fifth Aspect

In a fifth aspect, the fixing device according to the third aspect is characterized in that an outer diameter of the edge of the roller body in the width direction, the edge facing the ring is larger than an inner diameter of the knurled outer circumferential surface of the ring and smaller than an outer diameter of the knurled outer circumferential surface of the ring.

### Sixth Aspect

In a sixth aspect, the fixing device according to any one of the first to fifth aspects is characterized in that the ring has a knurled end face facing the roller body.

### Seventh Aspect

In a seventh aspect, the fixing device according to any one of the first to sixth aspects is characterized in that the ring has a portion adjacent to an outer circumferential surface of the ring and a portion adjacent to an inner circumferential surface of the ring that are on an end face facing the roller body. The ring has one of a projection formed on the portion adjacent to the outer circumferential surface of the ring and a recess formed in the portion adjacent to the inner circumferential surface of the ring. The portion adjacent to the outer circumferential surface of the ring contacts the folded portion having the shape folded along the inclined end face of the roller body.

### Eighth Aspect

In an eighth aspect, an image forming apparatus includes the fixing device according to any one of the first to seventh aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A fixing device comprising:
a fixing rotator;
a heater to heat the fixing rotator;
a pressure roller:
pressed against the fixing rotator to form a nip through which a sheet is conveyed; and
including:
a shaft extending in an axial direction; and
a roller body including a conductive surface layer having an outer circumferential surface contacting a surface of the fixing rotator at the nip; and
a ring:
having conductivity;
grounded; and
disposed on the shaft of the pressure roller to face an end face of the roller body,
wherein the roller body has the end face inclined from an edge of the outer circumferential surface to the shaft in a cross section along an axial line of the shaft of the pressure roller, and
the end face contacts the shaft at a position closer to the ring than the edge of the outer circumferential surface,
the conductive surface layer has a folded portion folded along the end face of the roller body, and
the folded portion contacts an end face of the ring.

2. The fixing device according to claim 1,
wherein the fixing rotator includes a fixing belt including:
a belt conductive layer; and
a belt surface layer over a part of the belt conductive layer, except for an end portion of the belt conductive layer in the axial direction,
wherein the end portion has an exposed portion not covered by the belt surface layer,
the belt surface layer has a resistance larger than a resistance of the belt conductive layer, and
the ring contacts the exposed portion and is electrically connected to the exposed portion of the belt conductive layer.

3. The fixing device according to claim 2,
wherein the ring has a knurled outer circumferential surface in contact with the exposed portion of the belt conductive layer.

4. The fixing device according to claim 3,
wherein the roller body has an edge in the axial direction, and
the edge faces the ring and has an outer diameter smaller than an inner diameter of the knurled outer circumferential surface of the ring.

5. The fixing device according to claim 3,
wherein the roller body has an edge in the axial direction, and
the edge faces the ring and has an outer diameter:
larger than an inner diameter of the knurled outer circumferential surface of the ring; and
smaller than an outer diameter of the knurled outer circumferential surface.

6. The fixing device according to claim 1,
wherein the ring has a knurled end face facing the roller body.

7. The fixing device according to claim 1, wherein the ring has, on an end face facing the roller body:
a first portion adjacent to an outer circumferential surface of the ring; and
a second portion adjacent to an inner circumferential surface of the ring, the ring has one of:
a projection on the first portion; or
a recess in the second portion, and
the first portion is in contact with the folded portion.

8. An image forming apparatus comprising the fixing device according to claim 1.
